(19) United States
(12) Patent Application Publication
(10) Pub. No.: US 2014/0365155 A1
(43) Pub. Date: Dec. 11, 2014

(54) COMPUTING DEVICE AND GAP ADJUSTMENT METHOD

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); LU YANG, Shenzhen (CN)

(21) Appl. No.: 14/297,886

(22) Filed: Jun. 6, 2014

(30) Foreign Application Priority Data
Jun. 6, 2013 (CN) 2013102232511

(51) Int. Cl. G01B 21/04

(52) U.S. Cl. CPC G01B 21/042
USPC 702/95

(57) ABSTRACT

A computing device reads outline points of a first accessory and processing points of a second accessory from a storage system. The computing device corresponds each of the processing points to one outline point, and calculates a deviation value between each of the processing points and the corresponding outline point. The computing device adjusts coordinates of the processing point according to the deviation value.

### FIELD

Embodiments of the present disclosure relate to measurement technology, and more particularly to a computing device and a gap adjustment method.

### BACKGROUND

A product (e.g., a mobile phone) includes a plurality of accessories (e.g., a shell, a screen, and a battery). During manufacturing, when a plurality of accessories are assembled into a single product, a gap between adjacent accessories may exceed a predetermined error range.

### BRIEF DESCRIPTION OF THE DRAWINGS

Implementations of the present technology will now be described, by way of example only, with reference to the attached figures, wherein:

FIG. 1 illustrates one embodiment of a computing device including a gap adjustment system.

FIG. 2 illustrates one embodiment of a gap adjustment method.

FIG. 3 illustrates one embodiment of outline points of a first accessory including error points.

FIG. 4 illustrates one embodiment of outline points of a first accessory having no error points.

FIG. 5 illustrates one embodiment of each of the outline points in FIG. 4 corresponding to a processing point of a second accessory.

FIG. 6 illustrates one embodiment of a table including a reference number and coordinates of each of the outline points in FIG. 5.

FIG. 7 illustrates one embodiment of coordinates of each of the processing points corresponding to the outline point in FIG. 5.

FIG. 8 illustrates one embodiment of a deviation value between each of the processing points and the corresponding outline point.

FIG. 9 illustrates one embodiment of adjusted coordinates of each of the processing points according the deviation value.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain accessories have been exaggerated to better illustrate details and features of the present disclosure

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

Furthermore, the term “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some non-limiting examples of non-transitory computer-readable media include CDs, DVDs, BLU-RAY, flash memory, and hard disk drives.

The present disclosure is described in relation to measurement technology.

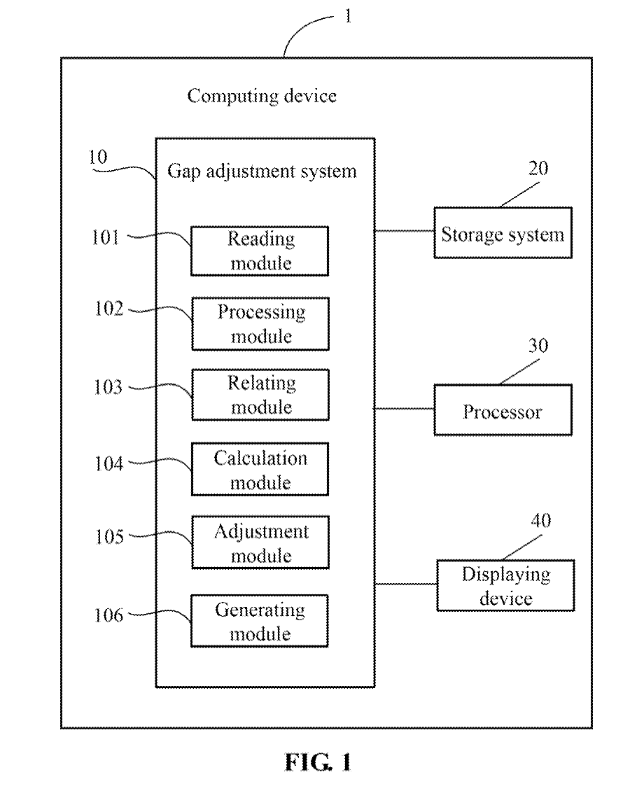

FIG. 1 illustrates a block diagram of one embodiment of a computing device including a gap adjustment system. In one embodiment, a computing device 1 includes a gap adjustment system 10, which includes a reading module 101, a processing module 102, a relating module 103, a calculation module 104, an adjustment module 105, and a generating module 106. The modules 101-106 can include computerized code in the form of one or more programs that are stored in a storage system 20 of the computing device 1. The computerized code includes instructions that are executed by the at least one processor 30 of the computing device 1 to provide functions for modules 101-106.

The storage system 20 stores coordinates of outline points of a first accessory. The coordinates of each of the outline points include at least an X-axis value, a Y-axis value, and a Z-axis value. The coordinates of each of the outline points are obtained from a three-dimensional scanner. In one embodiment, the three-dimensional scanner generates coordinates of the outline points of the first accessory when the three-dimensional scanner scans a surface of the first accessory. The storage system 20 further stores coordinates of processing points of a second accessory. The processing points of the second accessory are generated by a three-dimensional application (e.g., computer aided design (CAD) application). A computer numerical control (CNC) machine can manufacture the second accessory according to the processing points of the second accessory. The coordinates of each of the processing points includes at least an X-axis value, a Y-axis value, and a Z-axis value. The first accessory and the second accessory are two adjacent coupled accessories that are assembled into an object (e.g., a mobile phone). For example, the first accessory can be a screw cap, and the second accessory can be a screw. The screw cap and the screw are equipped into the mobile phone.

The storage system 20 can be a an internal storage system, such as a flash memory, a random access memory (RAM) for temporary storage of information, and/or a read-only memory (ROM) for permanent storage of information. The storage system 20 can also be an external storage system, such as an external hard disk, a storage card, or a data storage medium. In addition, the computing device 1 includes a displaying device 40. The displaying device 40 displays the outline points of the first accessory and the processing points of the second accessory.

The reading module 101 reads coordinates of the outline points of the first accessory and coordinates of the processing points of the second accessory from the storage system 20.

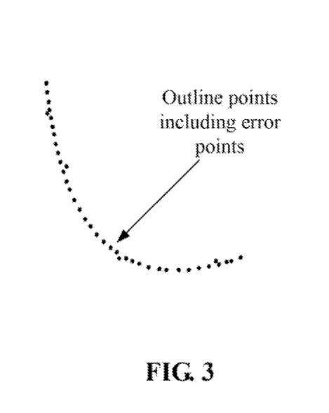

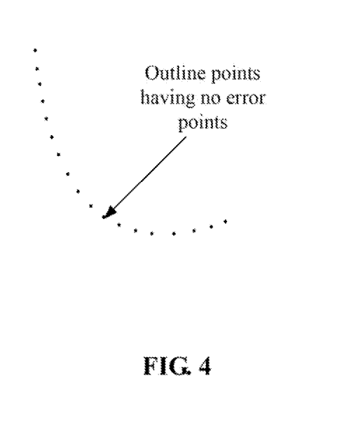

The processing module 102 eliminates error points from the outline points of the first accessory. In one embodiment, the processing module 102 calculates a distance between each two adjacent outline points. One of the outline points is determined to be an error point upon the condition that a distance between the outline point and one of adjacent outline points exceeds a predetermined threshold value (e.g., 0.01 millimeter). For example, assuming that the outline point A is adjacent to the outline point B and outline point C, if either of a distance between the outline point A and the outline point B, and a distance between the outline point A and the outline point C exceeds the predetermined threshold value, the outline point A is determined to be the error point. The processing module 102 eliminates the error point. FIG. 3 illustrates outline points including error points. FIG. 4 illustrates outline points having no error points.

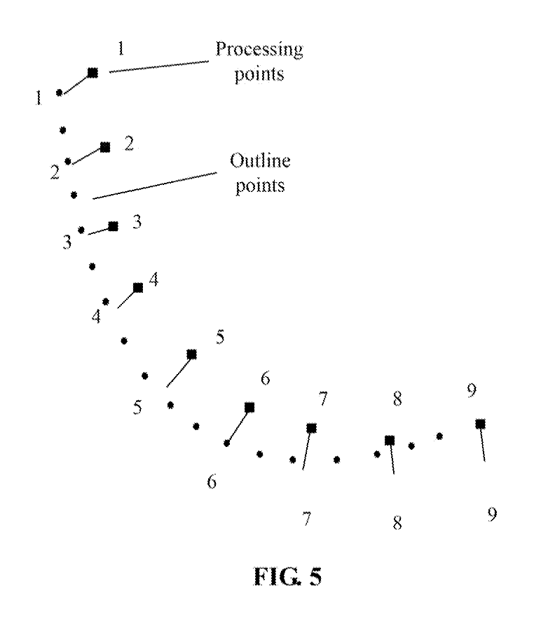

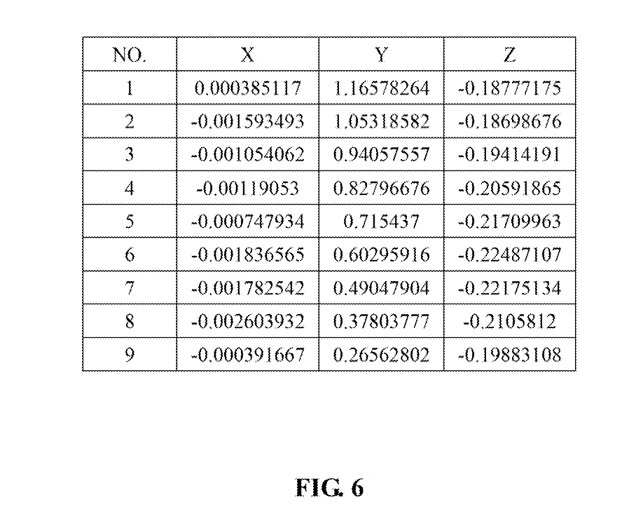

The relating module 103 establishes a relationship between each of the processing points with one outline point. In one embodiment, the relationship between each of the processing points with one outline point is established by: the relating module 103 calculates distances between one of the processing points and all of the outline points. The relating module 103 determines a minimum distance among the calculated distances, the relating module 103 determines an outline point corresponding to the minimum distance, and establishes the relationship between the processing point to the determined outline point. The relating module 103 further generates a reference number to each determined outline. As shown in FIG. 5, each of the processing points is represented as a black rectangle, and each of the outline points is represented as a circle. Each black rectangle is related to one circle by establishing the relationship using the relating module 103, and each corresponding circle is assigned to a reference number, such as, such as “1”, “2”, “3”, “4”, “5”, “6”, “7”, “8”, and “9”. In addition, the relating module 103 eliminates the outline points which have no relationship with any processing points. The relating module 103 further saves the reference numbers and the coordinates of each determined outline points into a file (e.g., a table or a list). As shown in FIG. 6, a table records nine reference number and coordinates of nine out lines.

The calculation module 104 calculates a deviation value between each of the processing points and an established outline point. The deviation value includes three values, namely the X-axis value, the Y-axis value and the Z-axis value.

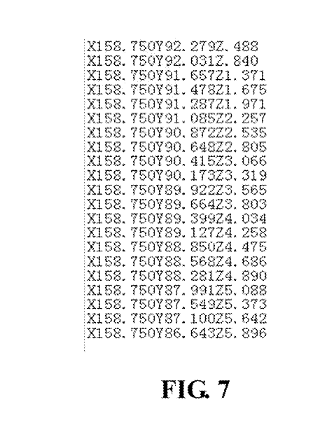

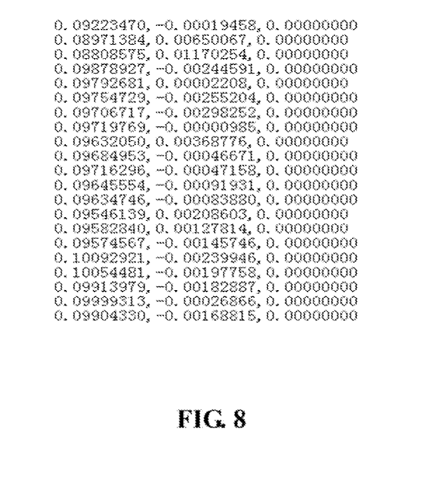

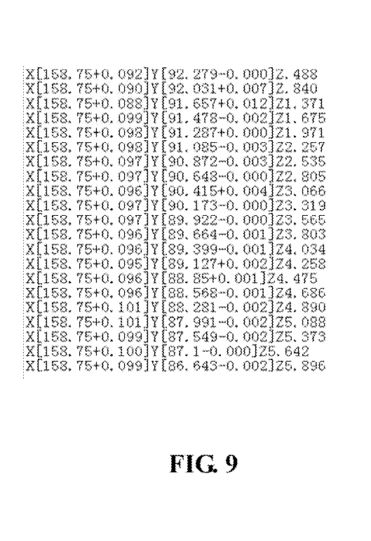

The adjustment module 105 adjusts coordinates of each of the processing points according to the deviation value, and acquires the adjusted coordinates of each of the processing points. In one embodiment, FIG. 7 illustrates the coordinates of the processing point, FIG. 8 illustrates the deviation values, and FIG. 9 illustrates the adjusted coordinates of the processing point. In addition, as shown in FIG. 9, the deviation values can be rounded to three decimal places when the deviation values are used to adjust coordinates of the processing point.

The generating module 106 generates a program according to the adjusted coordinates of each of the processing points. The generated program can control the CNC machine to produce the second accessory. The gap between the first accessory and the second accessory is adjusted if the coordinates of the processing point are adjusted according to the deviation value.

FIG. 3 is a flowchart illustrating one embodiment of a gap adjustment method. In the embodiment, the method is performed by execution of computer-readable software program codes or instructions by at least one processor of a computing device.

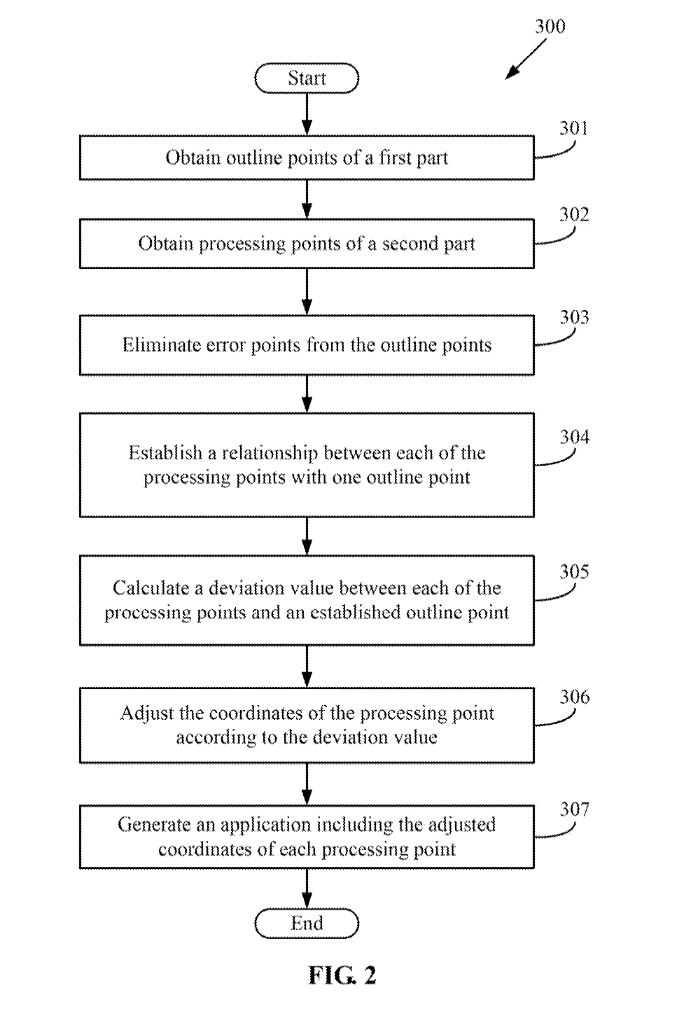

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks ca change according to the present disclosure. The exemplary method 300 can begin at block 301.

At block 301, a reading module reads coordinates of the outline points of a first accessory from the storage system.

At block 302, the reading module reads coordinates of the processing points of a second accessory from the storage system.

At block 303, the processing module eliminates error points from the outline points of the first accessory. In one embodiment, a distance of each two adjacent outline points is calculated. For example, assuming that the outline point A is adjacent to the outpoint B and outpoint C, if either of a distance between the outline point A and the outline point B, and a distance between the outline point A and the outline point C exceeds 0.01 millimeter, the outline point A is determined to be the error point. The processing module eliminates the outline point A. In addition, block 303 is not necessary. That is, block 303 can be deleted.

At block 304, a relating module establishes a relationship between each of the processing points with one outline point, generates a reference number to each determined outline, and saves the reference numbers and the coordinates of each determined outline into a table. In one embodiment, distances are calculated from the processing point A to all of the outline points, if a distance between the processing point A and the outline point A1 is minimum, the relationship is established between the processing point A and the outline point A1. As shown in FIG. 5, each black quadrilateral is corresponded to one circular point, and each corresponding circular point is assigned to a reference number, such as, “1”, “2”, “3”, “4”,“5”, “6”,“7”,“8”, and “9”.

At block 305, a calculation module calculates a deviation value between each of the processing points and an established outline point. The deviation value between each of the processing points and the corresponding outline point includes three values, namely the X-axis value, the Y-axis value and the Z-axis value. The deviation value is calculated according to the coordinates of each of the processing points and coordinates of a corresponding outline point.

At block 306, an adjustment module adjusts the coordinates of the processing point according to the deviation value. In one embodiment, FIG. 7 illustrates the coordinates of the processing point, FIG. 8 illustrates the deviation values, and FIG. 9 illustrates the adjusted coordinates of the processing point. In addition, as shown in FIG. 9, the deviation values can be rounded to three decimal places when the deviation values are used for adjusting coordinates of the processing point.

At block 307, a generating module generates a program according to the adjusted coordinates of each of the processing points. The generated program is used to control the CNC machine for producing the second accessory. In one embodiment, if the generated program is uploaded into the CNC machine, the second accessory is produced by the CNC machine.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the accessories within the principles of the present disclosure up to, and including the full extent established by the broad general meaning of the terms used in the claims. It will therefore be appreciated that the embodiments described above may be modified within the scope of the claims.

What is claimed is:

1. A computing device, the computing device comprising:
at least one processor; and
a storage system that stores one or more programs, which when executed by the at least one processor, cause the at least one processor to:
read coordinates of outline points of a first accessory of an object and processing points of a second accessory of the object from the storage system;
establish a relationship between each of the processing points with one outline point;
calculate a deviation value between each of the processing points and an established outline point;
adjust coordinates of each of the processing points according to the deviation value; and
generate a program according to the adjusted coordinates of each of the processing points.

2. The computing device of claim 1, wherein one of the outline points is determined to be an error point upon the condition that a distance between the outline point and one of adjacent outline points exceeds a predetermined threshold value.

3. The computing device of claim 2, wherein the at least one processor further:
eliminates the error point from the outline points of the first accessory.

4. The computing device of claim 1, wherein the relationship between each of the processing points with one outline point is established by:
calculating distances between one of the processing points and all of the outline points;
determining a minimum distance among the calculated distances;
determining an outline point corresponding to the minimum distance; and
establishing the relationship between the processing point to the determined outline point.

5. The computing device of claim 1, wherein the generated program is configured to control a computer numerical control (CNC) machine for manufacturing the second accessory.

6. The computing device of claim 1, wherein the first accessory and the second accessory are two adjacent coupled accessories of the object.

7. The computing device of claim 1, wherein the deviation value is calculated according to the coordinates of each of the processing points and coordinates of a corresponding outline point.

8. A gap adjustment method, the gap adjustment method comprising:
reading coordinates of outline points of a first accessory of an object and processing points of a second accessory of the object from a storage system of a computing device;
establishing a relationship between each of the processing points with one outline point;
calculating a deviation value between each of the processing points and an established outline point;
adjusting coordinates of each of the processing points according to the deviation value; and
generating a program according to the adjusted coordinates of each of the processing points.

9. The gap adjustment method of claim 8, wherein one of the outline points is determined to be an error point upon the condition that a distance between the outline point and one of adjacent outline points exceeds a predetermined threshold value.

10. The gap adjustment method of claim 9, wherein the at least one processor further:
eliminates the error point from the outline points of the first accessory.

11. The gap adjustment method of claim 8, wherein the relationship between each of the processing points with one outline point is established by:
calculating distances from one of the processing points to all of the outline points;
determining a minimum distance among the calculated distances;
determining an outline point corresponding to the minimum distance; and
establishing the relationship between the processing point to the determined outline point.

12. The gap adjustment method of claim 8, wherein the generated program is configured to control a computer numerical control (CNC) machine for manufacturing the second accessory.

13. The gap adjustment method of claim 8, wherein the first accessory and the second accessory are two adjacent coupled accessories of the object.

14. The gap adjustment method of claim 8, wherein the deviation value is calculated according to the coordinates of each of the processing points and coordinates of a corresponding outline point.

15. A non-transitory computer-readable medium having stored thereon instructions that, when executed by a computing device, causing the computing device to perform a gap adjustment method, the method comprising:
reading coordinates of outline points of a first accessory of an object and processing points of a second accessory of the object from a storage system of the computing device;
establishing a relationship between each of the processing points with one outline point;
calculating a deviation value between each of the processing points and an established outline point;
adjusting coordinates of each of the processing points according to the deviation value; and
generating a program according to the adjusted coordinates of each of the processing points.

16. The non-transitory computer-readable medium of claim 15, wherein one of the outline points is determined to be an error point upon the condition that a distance between the outline point and one of adjacent outline points exceeds a predetermined threshold value.

17. The non-transitory computer-readable medium of claim 16, wherein the at least one processor further:
eliminates the error point from the outline points of the first accessory.

18. The non-transitory computer-readable medium of claim 15, wherein the relationship between each of the processing points with one outline point is established by:
calculating distances from one of the processing points to all of the outline points;
determining a minimum distance among the calculated distances;
determining an outline point corresponding to the minimum distance; and
establishing the relationship between the processing point to the determined outline point.

19. The non-transitory computer-readable medium of claim 15, wherein the application is used to control the computer numerical control (CNC) machine for manufacturing the second accessory.

20. The non-transitory computer-readable medium of claim 15, wherein the deviation value is calculated according to the coordinates of each of the processing points and coordinates of a corresponding outline point.
